(19) United States
(12) Patent Application Publication
(10) Pub. No.: US 2024/0429566 A1
(43) Pub. Date: Dec. 26, 2024

(54) Battery Pack Tray and Battery Pack Tray Assembly

(71) Applicant: Tyco Electronics (Shanghai) Co., Ltd., Shanghai (CN)

(72) Inventors: Yu Zhang, Shanghai (CN); Xiao (Nichee) Zhou, Shanghai (CN); Ziwei (Vivi) Li, Shanghai (CN)

(73) Assignee: Tyco Electronics (Shanghai) Co., Ltd., Shanghai (CN)

(21) Appl. No.: 18/747,779

(22) Filed: Jun. 19, 2024

(30) Foreign Application Priority Data
Jun. 20, 2023 (CN) 202321586631.7

(51) Int. Cl. H01M 50/507; H01M 50/213; H01M 50/284; H01M 50/516

(52) U.S. Cl. CPC H01M 50/507; H01M 50/213; H01M 50/284; H01M 50/516

(57) ABSTRACT

A battery pack tray includes a plurality of sub trays arranged side by side in a first direction, each of the sub trays has a first side and a second side opposite the first side in the first direction. A row of connection holes is formed on the first side and a row of connection posts is formed on the second side. Each connection post of one of the sub trays is hot riveted to one of the connection holes of an adjacent sub tray to connect the sub trays. A diameter of the connection post is smaller than a minimum aperture of the connection hole; the connected sub trays can move relative to each other in the first direction and a second direction. Each connection post has a limiting flange formed by hot riveting. A diameter of the limiting flange is larger than the minimum aperture.

### CROSS-REFERENCE TO RELATED APPLICATION

This application claims the benefit of the filing date under 35 U.S.C. § 119(a)-(d) of Chinese Patent Application No. 202321586631.7, filed on Jun. 20, 2023.

### FIELD OF THE INVENTION

The present invention relates to a battery pack tray and a battery pack tray assembly comprising the battery pack tray.

### BACKGROUND OF THE INVENTION

A busbar of a battery pack is usually installed on a tray. The tray typically includes a tray body and a fixing portion formed on the tray body suitable for fixing the busbar. In the prior art, the tray is an integral injection molded part. Due to the increasing number of busbars in the battery pack, the volume of the tray has also become larger. Due to the high fixation accuracy required for the busbar, the injection tolerance requirements for the tray are becoming increasingly precise, making injection molding more difficult and costly.

In addition, in the prior art, connecting terminals are usually used to connect the busbars to a flexible circuit board or flexible flat cable to collect the voltage of the battery cells. One end of the connecting terminal is crimped onto the flexible circuit board or flexible flat cable, and the other end is soldered onto the busbar, which makes the electrical connection operation of the busbar very complex.

### SUMMARY OF THE INVENTION

A battery pack tray includes a plurality of sub trays arranged side by side in a first direction, each of the sub trays has a first side and a second side opposite the first side in the first direction. A row of connection holes is formed on the first side and a row of connection posts is formed on the second side. Each connection post of one of the sub trays is hot riveted to one of the connection holes of an adjacent sub tray to connect the sub trays. A diameter of the connection post is smaller than a minimum aperture of the connection hole; the connected sub trays can move relative to each other in the first direction and a second direction. Each connection post has a limiting flange formed by hot riveting. A diameter of the limiting flange is larger than the minimum aperture.

### BRIEF DESCRIPTION OF THE DRAWINGS

Features of the present invention will become more apparent by describing in detail exemplary embodiments thereof with reference to the accompanying drawings, in which:

FIG. 1 shows an illustrative plan view of a battery pack tray assembly according to an exemplary embodiment of the present invention;

FIG. 2 shows an illustrative exploded view of a battery pack tray assembly according to an exemplary embodiment of the present invention;

FIG. 3 shows an illustrative perspective view of a sub tray assembly according to an exemplary embodiment of the present invention;

FIG. 4 shows an illustrative exploded view of a sub tray assembly according to an exemplary embodiment of the present invention;

FIG. 5 shows an illustrative locally enlarged view of a sub tray assembly according to an exemplary embodiment of the present invention;

FIG. 6 shows a cross-sectional view of a sub tray assembly according to an exemplary embodiment of the present invention, wherein the busbar mounting component has not yet been fixed to the sub tray;

FIG. 7 shows a cross-sectional view of a sub tray assembly according to an exemplary embodiment of the present invention, wherein the busbar mounting member has been fixed to the sub tray;

FIG. 8 shows a cross-sectional view of a busbar mounting component and busbar according to an exemplary embodiment of the present invention;

FIG. 9 shows an illustrative view of a busbar mounting component and a breakdown of the busbar according to an exemplary embodiment of the present invention;

FIG. 10 shows an illustrative view of a plastic strip made by vacuum molding process according to an exemplary embodiment of the present invention;

FIG. 11 shows an illustrative perspective view of a sub tray according to an exemplary embodiment of the present invention;

FIG. 12 shows an illustrative perspective view of two sub trays according to an exemplary embodiment of the present invention, wherein the two sub trays have not yet been connected together;

FIG. 13 shows an enlarged sectional view of two sub trays according to an exemplary embodiment of the present invention;

FIG. 14 shows an illustrative perspective view of two sub trays according to an exemplary embodiment of the present invention, wherein the two sub trays have been connected together;

FIG. 15 shows an illustrative locally enlarged view of two sub trays according to an exemplary embodiment of the present invention;

FIG. 16 shows an illustrative perspective view of an electrical connection member and a mating connector according to an exemplary embodiment of the present invention;

FIG. 17 shows an illustrative exploded view of the electrical connection member and mating connector according to an exemplary embodiment of the present invention;

FIG. 18 shows an illustrative perspective view of a connector and a mating connector according to an exemplary embodiment of the present invention; and

FIG. 19 shows an illustrative perspective view of a connector and a mating connector according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

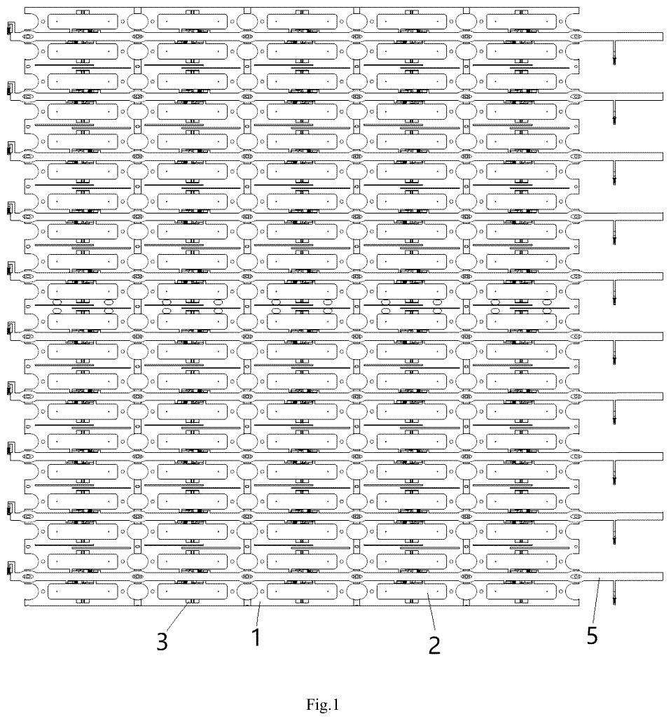

As shown in FIGS. 1-3 and 11-15, in an exemplary embodiment of the present invention, a battery pack tray 1 is disclosed. The battery pack tray 1 includes multiple sub trays 10. Multiple sub trays 10 are arranged side by side in the first direction X. The sub tray 10 has a first and second side opposite to each other in the first direction X. A row of connection holes 110 and a row of connection posts 120 are formed on the first and second sides of the sub tray 10, respectively. The connection post 120 of one of the adjacent sub trays 10 is hot riveted to the connection hole 110 of the other of the adjacent sub trays 10, so that multiple sub trays 10 are connected to each other.

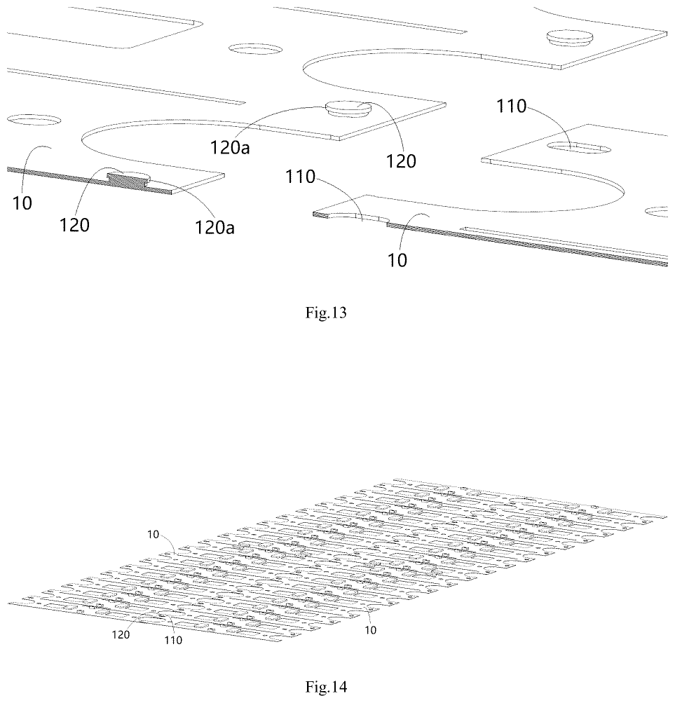

As shown in FIGS. 12-15, in the illustrated embodiment, the diameter of the connection post 120 is smaller than the minimum aperture of the connection hole 110 to allow the two connected sub trays 10 to move relative to each other in the first direction X and the second direction Y perpendicular to the first direction X. The connection post 120 has a limiting flange 120a formed by hot riveting, as shown in FIG. 13, and the diameter of the limiting flange 120a is greater than the minimum aperture of the connection hole 110 to prevent the connection post 120 from being detached from the connection hole 110 along its axis. In the illustrated embodiments, the connection hole 110 is elliptical in shape and has the maximum aperture in the first direction X and the minimum aperture in the second direction Y.

As shown in FIG. 5, in the illustrated embodiment, a positioning protrusion 11 is formed on the sub tray 10, and a cross hole 12 is formed on the positioning protrusion 11. The positioning protrusion 11 is suitable for fitting with a positioning recess 31 on a busbar mounting component 3 to position a busbar mounting component 3. The cross hole 12 is suitable for engaging with a fixing column 32 on the busbar mounting component 3 to fix the busbar mounting component 3.

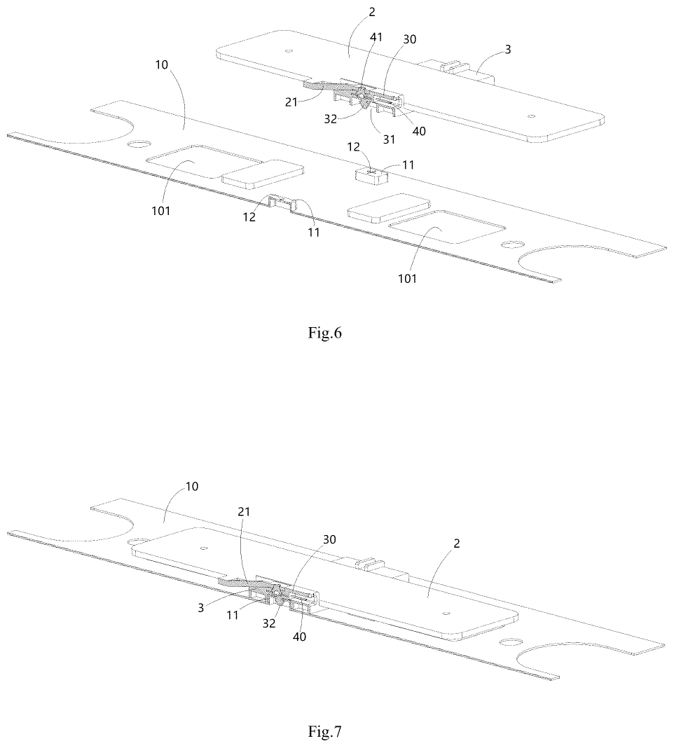

As shown in FIG. 6, in the illustrated embodiments, a through hole 101 is formed in the sub tray 10 that allows the electrode end of the battery cell to pass through, so that the electrode end of the battery cell can pass through the through hole 101 and be electrically connected to the busbar 2 fixed on the sub tray 10.

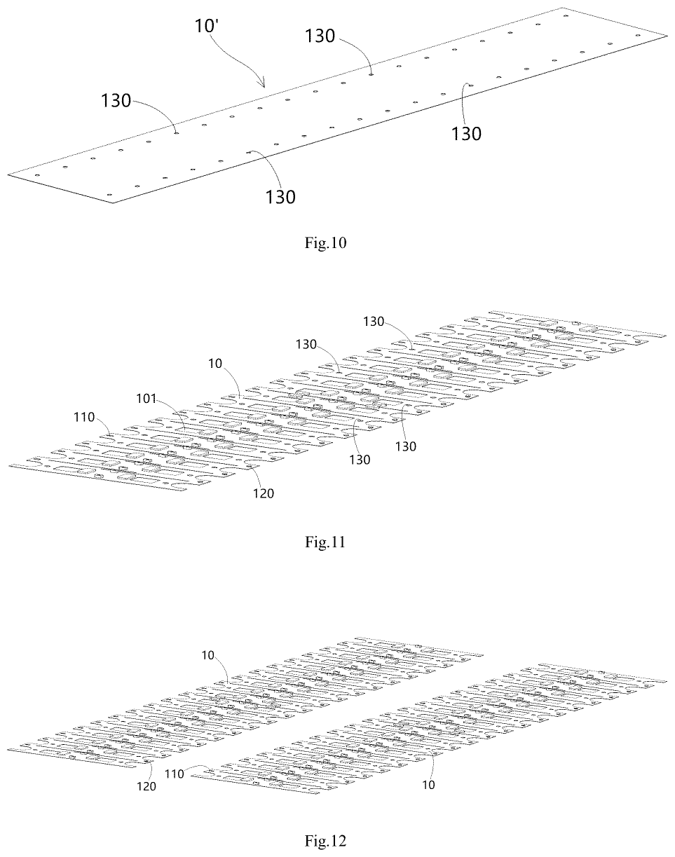

As shown in FIG. 10, in the illustrated embodiments, when manufacturing the sub tray 10, a vacuum forming process is first used to manufacture a plastic tape 10′ or plastic strip 10′ as shown in FIG. 10, and then the plastic tape 10′ is stamped and cut to form the sub tray 10 as shown in FIG. 11. This can reduce the processing difficulty and manufacturing cost of large-sized battery pack tray 1. In the illustrated embodiment, the sub tray 10 is an integral punching part formed by punching the plastic tape 10′. A row of positioning holes 130 are formed on each of two longitudinal side edges of the plastic tape 10′, which are used for positioning and conveying the plastic tape 10′ when punching the plastic tape 10′ and installing the busbar assembly on the sub tray 10. In this way, it is possible to achieve fully automated production of the punching process of the plastic tape 10′ and the installation operation of the busbar assembly, improving production efficiency.

In another exemplary embodiment of the present invention, a battery pack tray assembly is also disclosed. The battery pack tray assembly includes: a battery pack tray 1, a busbar 2, and a busbar mounting component 3. The busbar mounting component 3 is fixed to the sub tray 10. The busbar 2 is installed on the busbar mounting component 3.

As shown in FIG. 5, in the illustrated embodiments, a positioning recess 31 is formed on the bottom of each end of the busbar mounting component 3, and the positioning protrusion 11 on the sub tray 10 is embedded in the positioning recess 31. A fixing column 32 is formed on each end of the busbar mounting component 3, the fixing column 32 is located in the positioning recess 31 and inserted into the cross hole 12 on the sub tray 10.

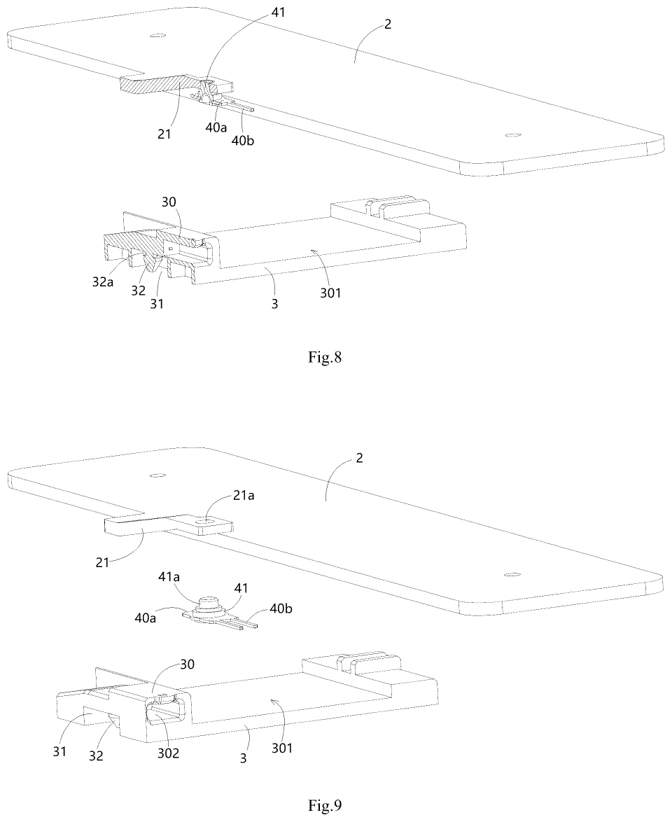

As shown in FIG. 8, in the illustrated embodiments, an annular groove 32a is formed on the fixing column 32, and the edge of the cross hole 12 on the sub tray 10 is snapped in the annular groove 32a of the fixing column 32, so that the fixing column 32 is engaged with the cross hole 12.

As shown in FIG. 9, in the illustrated embodiment, a positioning slot 301 is formed on the top of the busbar mounting component 3, and the busbar 2 is positioned and installed in the positioning slot 301.

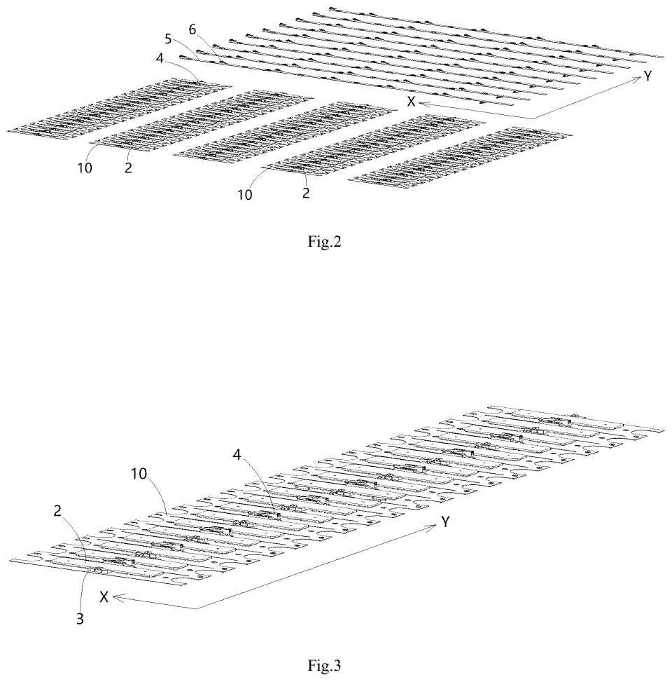

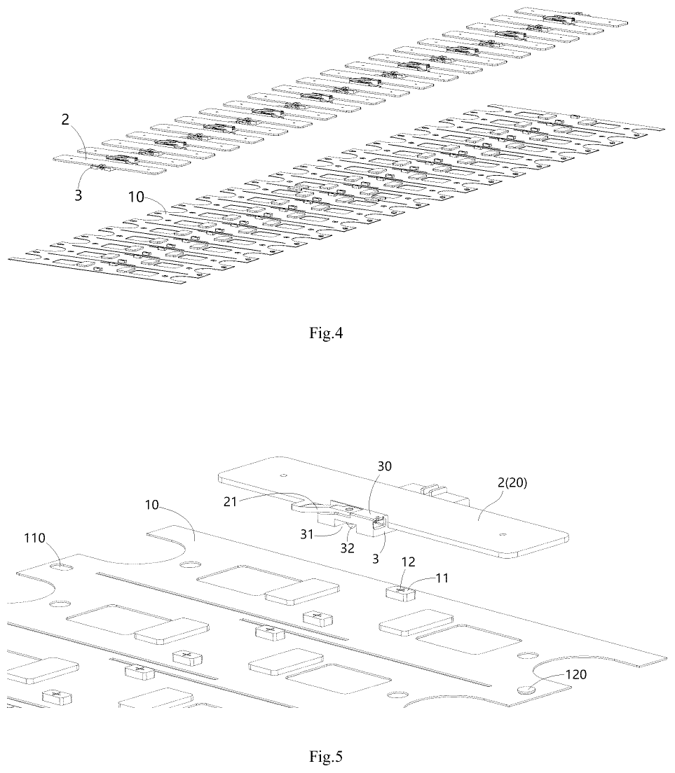

As shown in FIG. 6, in the illustrated embodiments, the battery pack tray assembly further comprises a terminal 40, which is provided in the end 30 of the busbar mounting component 3 and electrically connected to the busbar 2. The terminal 40 and the end 30 of the busbar mounting component 3 form a connector 4 suitable for mating with a connector 6, shown in FIGS. 2 and 3, and the end 30 of the busbar mounting component 3 forms the housing of the connector 4.

As shown in FIG. 6, in the illustrated embodiments, the battery pack tray assembly further includes a connecting component 41, which is provided in the end 30 of the busbar mounting component 3 and electrically connects the busbar 2 and terminal 40.

In the illustrated embodiments, the busbar mounting component 3 is an injection molded part formed on the terminal 40 and the connecting component 41 by injection molding technology, so that the busbar mounting component 3, the terminal 40, and the connecting component 41 become an integral part.

As shown in FIGS. 5 to 9, in the illustrated embodiments, the busbar 2 comprises a main body 20 and an elastic connection arm 21. The main body 20 is installed on the busbar mounting component 3. The clastic connection arm 21 is connected to the side of the main body 20. The connecting component 41 electrically connects the elastic connection arm 21 of busbar 2 and the terminal 40.

In the illustrated embodiments, the busbar 2 is an integral stamped part. The elastic connection arm 21 of busbar 2 is electrically connected to the terminal 40 to collect the voltage of the battery cells. In the illustrated embodiment, due to the flexibility of the elastic connection arm, it can absorb the stress concentration caused by the heating of the battery cells.

As shown in FIG. 9, in the illustrated embodiments, an engagement hole 21a is formed in the end of the elastic connection arm 21 of the busbar 2, and the upper end 41a of the connecting component 41 is columnar and pressed into the engagement hole 21a on the elastic connection arm 21 to be electrically connected to the elastic connection arm 21.

As shown in FIGS. 8 and 9, in the illustrated embodiments, the terminal 40 comprises a base portion 40a and a pin portion 40b, and the lower end of the connecting component 41 is riveted, soldered, or crimped onto the base portion 40a of the terminal 40. An insertion hole 302 is formed in the end 30 of the busbar mounting component 3, and the pin portion 40b of terminal 40 is accommodated in the insertion hole 302 to be electrically connected to the mating connector 6 inserted into the insertion hole 302.

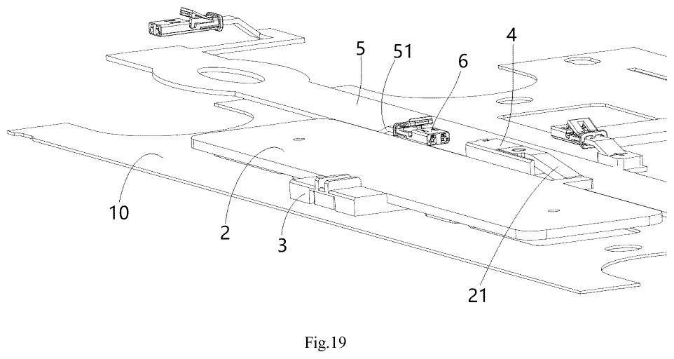

As shown in FIGS. 16 to 19, in the illustrated embodiments, the battery pack tray assembly further includes an electrical connection member 5 and multiple mating connectors 6. The electrical connection member 5 is in a strip shape and extends along the first direction X. Multiple mating connectors 6 are electrically connected to the electrical connection member 5. Multiple mating connectors 6 are respectively mated with the multiple connectors 4 on battery pack tray 1 to connect multiple busbars 2 on battery pack tray 1 to the electrical connection member 5.

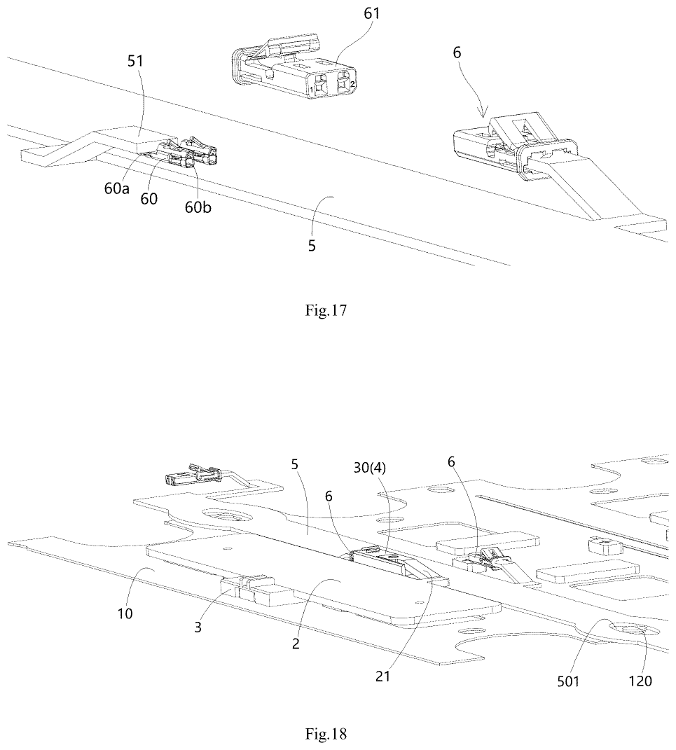

As shown in FIG. 17, in the illustrated embodiments, the mating connector 6 comprises a mating housing 61 and a mating terminal 60 provided in the mating housing 61. One end 60a of the mating terminal 60 is electrically connected to the electrical connection member 5, and the other end 60b of the mating terminal 60 is electrically connected to the terminal 40 of the connector 4.

In the illustrated embodiments, the electrical connection member 5 is a flexible circuit board, and an elastic arm 51 is formed on the side of the flexible circuit board. One end 60a of the mating terminal 60 is crimped onto the elastic arm 51 of the flexible circuit board. However, the present invention is not limited to the illustrated embodiments. For example, in another exemplary embodiment of the present invention, the electrical connection member 5 may also be a flexible flat cable, with one end 60a of the mating terminal 60 crimped onto the flexible flat cable.

As shown in FIG. 18, in the illustrated embodiments, an avoidance hole 501 is formed on the electrical connection member 5 to avoid the connection column 120 on the sub tray 10, so that the movement of the sub tray 10 is not constrained by the electrical connection member 5.

In the illustrated embodiments, the battery pack tray assembly comprises multiple electrical connection members 5, which are arranged side by side in the second direction Y perpendicular to the first direction X and spaced at a predetermined distance from each other.

In another exemplary embodiment of the present invention, a busbar installation module is also disclosed. The busbar installation module includes: a busbar mounting component 3 and a terminal 40. The busbar mounting component 3 is used to install the busbar 2 onto the battery pack tray 1. The terminal 40 is located at the end 30 of the busbar mounting component 3 for electrical connection to the busbar 2. The terminal 40 and the end 30 of the busbar mounting component 3 form a connector 4 suitable for mating with a connector 6, and the end 30 of the busbar mounting component 3 forms the housing of connector 4.

As shown in FIGS. 5 to 7, in the illustrated embodiments, a fixing column 32 is formed on the bottom of each end of the busbar mounting component 3, the fixing column 32 is used to insert into the cross hole 12 on the battery pack tray 1 to fix the busbar mounting component 3 to the battery pack tray 1. In the illustrated embodiments, a positioning recess 31 is formed on the bottom of each end of the busbar mounting component 3, and the fixing column 32 is located in the positioning recess 31. The positioning recess 31 is used to fit with the positioning protrusion 11 on the battery pack tray 1 to position the busbar mounting component 3.

As shown in FIG. 8, in the illustrated embodiments, a circular groove 32a is formed on the fixing column 32, and the edge of the cross hole 12 on the battery pack tray 1 is snapped in the circular groove 32a of the fixing column 32, so that the fixing column 32 is engaged with the cross hole 12. A positioning slot 301 is formed on the top of the busbar mounting component 3, and the busbar 2 is positioned and installed in the positioning slot 301.

As shown in FIGS. 8 and 9, in the illustrated embodiments, the busbar installation module further includes a connecting component 41, which is provided in the end 30 of the busbar mounting component 3 and electrically connects the busbar 2 and the terminal 40. In the illustrated embodiments, the busbar mounting component 3 is an injection molded part formed on the terminal 40 and the connecting component 41 by injection molding technology, so that the busbar mounting component 3, the terminal 40, and the connecting component 41 become an integral part.

As shown in FIG. 9, in the illustrated embodiments, the terminal 40 comprises a base portion 40a and a pin portion 40b, and the lower end of the connecting component 41 is riveted, soldered, or crimped onto the base portion 40a of the terminal 40. An insertion hole 302 is formed in the end 30 of the busbar mounting component 3, and the pin portion 40b of terminal 40 is accommodated in the insertion hole 302 to be electrically connected to the mating connector 6 inserted into the insertion hole 302.

In another exemplary embodiment of the present invention, a busbar assembly is also disclosed. The busbar assembly includes: the aforementioned busbar installation module and the busbar 2. The busbar 2 includes a main body 20 and an elastic connection arm 21. The main body 20 of busbar 2 is installed on the busbar mounting component 3. The elastic connection arm 21 is connected to the side of the main body 20. The elastic connection arm 21 of busbar 2 is electrically connected to the terminal 40 of the busbar installation module.

As shown in FIG. 9, in the illustrated embodiments, an engagement hole 21a is formed in the end of the clastic connection arm 21 of the busbar 2. The upper end 41a of the connection component 41 of the busbar installation module is columnar and pressed into the engagement hole 21a on the elastic connection arm 21 to be electrically connected to the elastic connection arm 21.

In another exemplary embodiment of the present invention, a sub tray assembly is also disclosed. The sub tray assembly includes: a sub tray 10 and multiple aforementioned busbar assemblies. Multiple busbar assemblies are installed on the sub tray 10.

As shown in FIG. 5, in the illustrated embodiments, a positioning protrusion 11 is formed on the sub tray 10, and a cross hole 12 is formed on the positioning protrusion 11. The positioning protrusion 11 is suitable for fitting with the positioning recess 31 on the busbar mounting component 3 to position the busbar mounting component 3. The cross hole 12 is suitable for engaging with the fixing column 32 on the busbar mounting component 3 to fix the busbar mounting component 3.

In the illustrated embodiments, a through hole 101 is formed in the sub tray 10 that allows the electrode end of the battery cell to pass through, so that the electrode end of the battery cell can pass through the through hole 101 and be electrically connected to the busbar 2 fixed on the sub tray 10.

In another exemplary embodiment of the present invention, a battery pack tray assembly is also disclosed. The battery pack tray assembly includes multiple aforementioned sub tray assemblies, with multiple sub trays 10 arranged side by side in the first direction X and connected to each other to form a battery pack tray 1.

As shown in FIGS. 13 to 15, in the illustrated embodiments, the sub tray 10 has opposite first and second sides in the first direction X, and a row of connection holes 110 and a row of connection posts 120 are formed on the first and second sides of the sub tray 10, respectively. The connection post 120 of one of the adjacent sub trays 10 is hot riveted to the connection hole 110 of the other of the adjacent sub trays 10, so that multiple sub trays 10 are connected to each other.

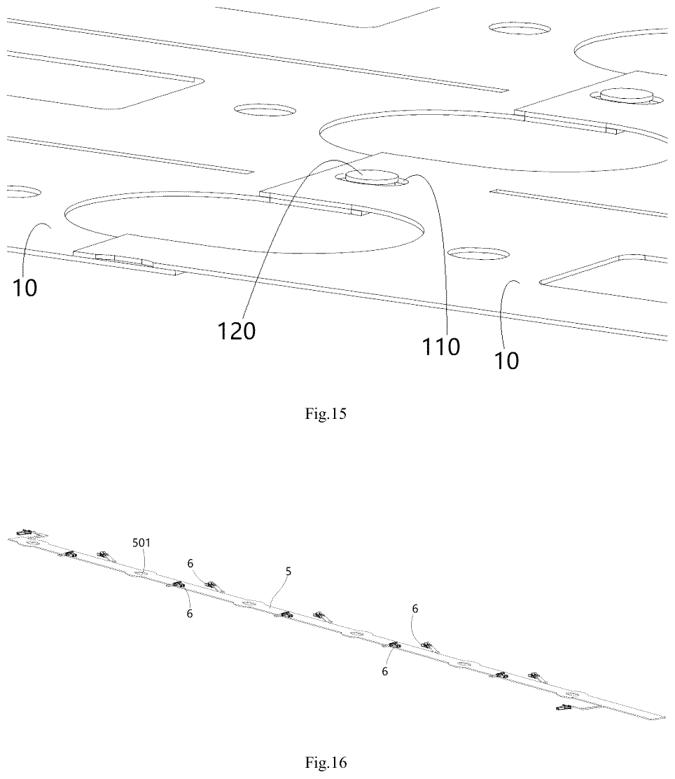

As shown in FIG. 15, the diameter of the connection post 120 is smaller than the minimum aperture of the connection hole 110 to allow the two connected sub trays 10 to move relative to each other in the first direction X and the second direction Y perpendicular to the first direction X. The connection post 120 has a limiting flange 120a formed by hot riveting, and the diameter of the limiting flange 120a is greater than the minimum aperture of the connection hole 110 to prevent the connection post 120 from being detached from the connection hole 110 along its axis. In the illustrated embodiments, the connection hole 110 is elliptical in shape and has the maximum aperture in the first direction X and the minimum aperture in the second direction Y.

In the illustrated embodiments, the battery pack tray assembly further comprises: an electrical connection member 5 and multiple mating connectors 6. The electrical connection member 5 is in a strip shape and extends along the first direction X. Multiple mating connectors 6 are electrically connected to the electrical connection member 5. Multiple mating connectors 6 are respectively mated with multiple connectors 4 on the battery pack tray 1 to connect multiple busbars 2 on battery pack tray 1 to the electrical connection member 5.

As shown in FIG. 17, in the illustrated embodiments, the mating connector 6 comprises a mating housing 61 and a mating terminal 60 provided in the mating housing 61. One end 60a of the mating terminal 60 is electrically connected to the electrical connection member 5, and the other end 60b of the mating terminal 60 is electrically connected to the terminal 40 of the connector 4.

As shown in FIG. 17, in the illustrated embodiments, the electrical connection member 5 is a flexible circuit board, and an elastic arm 51 is formed on the side of the flexible circuit board. One end 60a of the mating terminal 60 is crimped onto the elastic arm 51 of the flexible circuit board. However, the present invention is not limited to the illustrated embodiments. For example, in another exemplary embodiment of the present invention, the electrical connection member 5 may be a flexible flat cable, and one end 60a of the mating terminal 60 is crimped onto the flexible flat cable.

As shown in FIG. 18, in the illustrated embodiments, an avoidance hole 501 is formed on the electrical connection member 5 to avoid the connection column 120 on the sub tray 10, so that the movement of the sub tray 10 is not constrained by the electrical connection member 5.

In the illustrated embodiments, the battery pack tray assembly comprises multiple electrical connection members 5, which are arranged side by side in the second direction Y perpendicular to the first direction X and spaced at a predetermined distance from each other.

In the aforementioned exemplary embodiments of the present invention, the size of the sub tray used for splicing the battery pack tray is small and easily formed. Therefore, the present invention reduces the processing difficulty and manufacturing cost of large-sized battery pack tray. Moreover, the two connected sub trays can move relative to each other, thereby absorbing the stress caused by the thermal expansion of the battery cells.

In some exemplary embodiments of the present invention, the busbar can be electrically connected to a flexible circuit board or flexible flat cable through two mated connectors, simplifying the electrical connection operation of the busbar.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A battery pack tray, comprising:
a plurality of sub trays arranged side by side in a first direction, each of the sub trays has a first side and a second side opposite the first side in the first direction;
a row of connection holes formed on the first side of each of the sub trays; and
a row of connection posts formed on the second side of each of the sub trays, each connection post of one of the sub trays is hot riveted to one of the connection holes of an adjacent sub tray to connect the sub trays together, a diameter of the connection post is smaller than a minimum aperture of the connection hole and the sub trays that are connected can move relative to each other in the first direction and a second direction perpendicular to the first direction, each connection post has a limiting flange formed by hot riveting, a diameter of the limiting flange is larger than the minimum aperture of the connection hole.

2. The battery pack tray of claim 1, wherein the connection hole is elliptical in shape and has a maximum aperture in the first direction and the minimum aperture in the second direction.

3. The battery pack tray of claim 1, wherein a positioning protrusion is formed on each of the sub trays and a cross hole is formed on the positioning protrusion, the positioning protrusion mates with a positioning recess on a busbar mounting component to locate the busbar mounting component, the cross hole engages a fixing column on the busbar mounting component to secure the busbar mounting component.

4. The battery pack tray of claim 1, wherein a through hole is formed in each of the sub trays, an electrode end of a battery cell is capable of passing through the through hole to be electrically connected to a busbar fixed on the sub tray.

5. The battery pack tray of claim 1, wherein each of the sub trays is an integral punching piece formed by punching a plastic strip, a row of positioning holes is formed on each of a pair of longitudinal side edges of the plastic strip, the positioning holes position and transport the plastic strip when punching the plastic strip and installing a busbar assembly.

6. A battery pack tray assembly, comprising:
a battery pack tray includes a plurality of sub trays arranged side by side in a first direction, each of the sub trays has a first side and a second side opposite the first side in the first direction, a row of connection holes is formed on the first side of each of the sub trays, and a row of connection posts is formed on the second side of each of the sub trays, each connection post of one of the sub trays is hot riveted to one of the connection holes of an adjacent sub tray to connect the sub trays together, a diameter of the connection post is smaller than a minimum aperture of the connection hole and the sub trays that are connected can move relative to each other in the first direction and a second direction perpendicular to the first direction, each connection post has a limiting flange formed by hot riveting, a diameter of the limiting flange is larger than the minimum aperture of the connection hole;
a busbar mounting component fixed to one of the sub trays; and
a busbar installed on the busbar mounting component.

7. The battery pack tray assembly of claim 6, wherein a positioning recess is formed on a bottom of each of a pair of ends of the busbar mounting component, a positioning protrusion on one of the sub trays is embedded in the positioning recess, a fixing column is formed on each of a pair of ends of the busbar mounting component, the fixing column is located in the positioning recess and inserted into a cross hole on the positioning protrusion.

8. The battery pack tray assembly of claim 7, wherein a circular groove is formed on the fixing column, an edge of the cross hole is snapped in the circular groove to engage the fixing column with the cross hole.

9. The battery pack tray assembly of claim 6, wherein a positioning slot is formed on a top of the busbar mounting component, the busbar is positioned and installed in the positioning slot.

10. The battery pack tray assembly of claim 6, further comprising a terminal in an end of the busbar mounting component that is electrically connected to the busbar, the terminal and the end of the busbar mounting component form a connector suitable for mating with a mating connector, the end of the busbar mounting component forms a housing of the connector.

11. The battery pack tray assembly of claim 10, further comprising a connecting component arranged in the end of the busbar mounting component and electrically connecting the busbar to the terminal.

12. The battery pack tray assembly of claim 11, wherein the busbar mounting component is a molded component formed on the terminal and the connecting component by an injection molding process, the busbar mounting component, the terminal, and the connecting component are an integral part.

13. The battery pack tray assembly of claim 11, wherein the busbar includes:
a main body installed on the busbar mounting component; and
an elastic connection arm connected to a side of the main body, the connecting component electrically connects the elastic connection arm of the busbar and the terminal.

14. The battery pack tray assembly of claim 13, wherein an engagement hole is formed on an end of the elastic connection arm of the busbar, and an upper end of the connecting component is columnar and pressed into the engagement hole on the elastic connection arm to be electrically connected to the elastic connection arm.

15. The battery pack tray assembly of claim 14, wherein the terminal has a base portion and a pin portion, a lower end of the connecting component is riveted, soldered, or crimped onto the base portion of the terminal, an insertion hole is formed in the end of the busbar mounting component, the pin portion of the terminal is accommodated in the insertion hole and electrically connected to the mating connector inserted into the insertion hole.

16. The battery pack tray assembly of claim 10, further comprising:
an electrical connection member that has a strip shape and extends along the first direction; and
a plurality of mating connectors electrically connected to the electrical connection member, the mating connectors are respectively mated with a plurality of connectors on the battery pack tray to electrically connect a plurality of busbars on the battery pack tray to the electrical connection member.

17. The battery pack tray assembly of claim 16, wherein the mating connectors each include a mating housing and a mating terminal provided in the mating housing, a first end of the mating terminal is electrically connected to the electrical connection member and a second end of the mating terminal is mated with the terminal of one of the connectors.

18. The battery pack tray assembly of claim 17, wherein the electrical connection member is a flexible circuit board, an elastic arm is formed on a side of the flexible circuit board, the first end of the mating terminal is crimped onto the elastic arm of the flexible circuit board.

19. The battery pack tray assembly of claim 17, wherein the electrical connection member is a flexible flat cable, the first end of the mating terminal is crimped onto the flexible flat cable.

20. The battery pack tray assembly of claim 16, wherein an avoidance hole is formed in the electrical connection member for avoiding the connection post on the sub tray, movement of the sub tray is not constrained by the electrical connection member.
